(19) United States
(12) Patent Application Publication
(10) Pub. No.: US 2010/0064309 A1
(43) Pub. Date: Mar. 11, 2010

(54) Broadcast Signal Transmitting Device

(76) Inventor: Gennady Klemeshev, Moscow (RU)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/593,189

(22) PCT Filed: Jul. 25, 2008
(86) PCT No.: PCT/RU2008/000491

§ 371 Date: Nov. 5, 2009

(30) Foreign Application Priority Data
Jul. 31, 2007 (RU) 2007129370

(51) Int. Cl. H04N 7/16

(52) U.S. Cl. 725/25

(57) ABSTRACT

The declared object to concern to the devices which are carrying out sale of audio-video of the information and an interactive announcement. The purpose of offered utility model is the possibility: increases of quantity of speakers and consumers, interactive interaction of the speaker and the consumer, carrying out of payments inside of the device in a current mode. In a concrete example the device of transfer of a broadcasting signal consists of blocks of memory which can be executed in the form of a separate microcircuit or the separate cells of memory allocated in a microcircuit. The block of management and the block of calculation of cost, can be executed a kind of the microprocessor which is carrying out alternately functions of the block of management and block of calculation of cost. The speaker can be executed in the form of the device capable to accept-transfer a digital signal which can comprise audio, video data, files, messages. The consumer is executed in the form of the device capable to accept-transfer, interpret (to process and give result in the form of the image and a sound) a received digital signal. The block of the sanction, is executed in the form of the device transferring to the block of management of a command of the sanction or prohibition of any commands and operations.

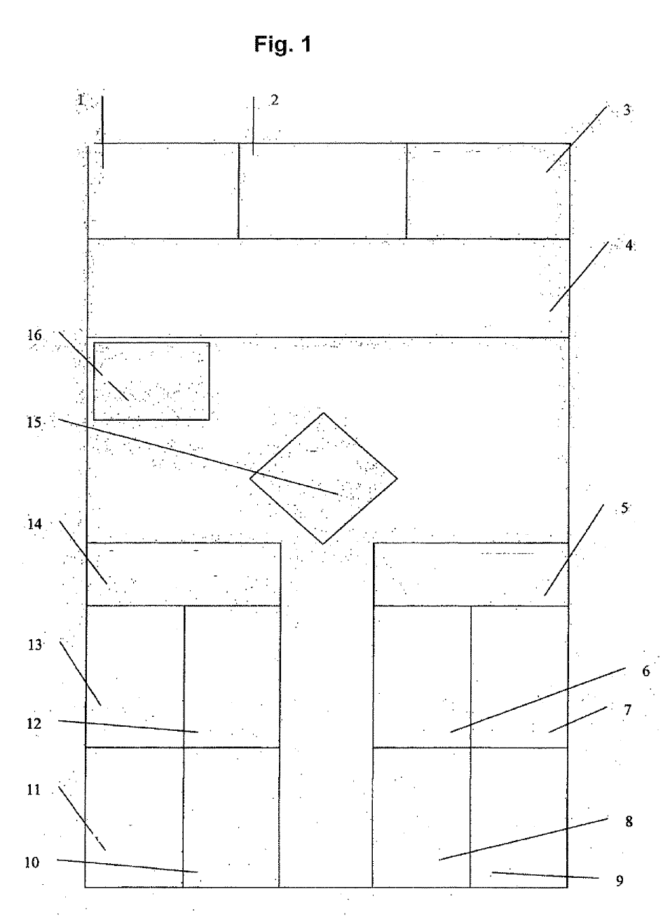

### RELATED PATENTS

The present invention relates to devices for selling audio/video information and interactive broadcasting.

### PRIOR ART

It is known in the art to employ a device for selling software products (http://www.keepsoft.ru/homebuh_reg.htm, 1998).

The prior art device comprises a storage unit holding the seller's account, a storage unit holding the list of available services, a storage unit holding the seller's name, a broadcast unit, a consumer unit, a storage unit holding the prices for services, a storage unit holding the name of the services, a storage unit holding the buyer's name, a storage unit holding the buyer's account, a control unit, an authorization unit and a data transmission bus.

The user employing the prior art device receives the desired software product via the data transmission bus with the aid of the consumer unit and the broadcast unit.

To launch the software product activation process, the value of the software product recorded in the storage unit holding the prices of the services is deducted from the storage unit holding the buyer's account, and, once the authorization unit confirms the payment, the control unit instructs the broadcast unit to send an e-mail containing the software activation code to the buyer.

The prior art device has a number of disadvantages, to wit, it does not permit increasing the number of broadcast units, it lacks interactivity and has no real-time cost calculation capability.

An object of the present invention is to increase the number of broadcast and consumer units, provide for the interaction of the broadcast and consumer units and provide an ability to perform real-time cost calculations inside the device.

### APPLICATION DISCLOSURE

The foregoing object is attained in a device for transmitting a broadcast signal comprising a fourth storage unit holding the seller's account, a fifth storage unit holding the list of services, a sixth storage unit holding the seller's name, a broadcast unit, a seventh storage unit holding the prices of the services, a tenth storage unit holding the name of the services, a ninth storage unit holding the buyer's name, a control unit and an authorization unit, all said units being connected to a data transmission bus, characterized in that it further comprises a first storage unit holding the list of buyers, a second storage unit holding the provider's account, a third storage unit holding the list of sellers, a cost calculator, an eighth storage unit holding the purchase price, an eleventh storage unit holding the buyer's account and a consumer unit, said additional storage units and consumer unit being connected to the data transmission bus while the consumer unit and the broadcast unit are interconnected by means of a communication line, and the data transmission bus is so designed as to allow of connecting thereto additional fourth, fifth, sixth, seventh, eighth, ninth, tenth and eleventh storage units as well as additional broadcast units and consumer units, while the communication line is so designed as to allow said additional broadcast and consumer units to transmit and/or receive information.

### BRIEF DESCRIPTION OF THE ACCOMPANYING DRAWINGS

The invention is illustrated by a drawing showing an overall schematic of the proposed device.

### VARIOUS EMBODIMENTS OF THE INVENTION

The device of the invention is realized as follows:

Referring now to the accompanying drawing, the proposed device for transmitting a broadcast signal comprises a first storage unit holding the list of buyers, 1 (hereinafter first storage unit), a second storage unit holding the provider's account, 2 (hereinafter second storage unit), a third storage unit holding the list of sellers, 3 (hereinafter third storage unit), a cost calculator 4, a fourth storage unit holding the seller's account, 5 (hereinafter fourth storage unit), a fifth storage unit holding the list of services, 6 (hereinafter fifth storage unit), a sixth storage unit holding the seller's name, 7 (hereinafter sixth storage unit), a broadcast unit 8, a seventh storage unit holding the prices of the services, 9 (hereinafter seventh storage unit), a consumer unit 10, an eighth storage unit holding the purchase price, 11 (hereinafter eighth storage unit), a tenth storage unit holding the name of the services, 10 (hereinafter tenth storage unit), a ninth storage unit holding the buyer's name, 13 (hereinafter ninth storage unit), an eleventh storage unit holding the buyer's account, 14 (hereinafter eleventh storage unit), a control unit 15 and an authorization unit 16.

In a specific example (shown), which is a particular embodiment of the invention, the device for transmitting a broadcast signal will be seen to comprise storage units that can be integrated into a separate microcircuit or as dedicated memory cells in a microcircuit. The control unit 15 and the cost calculator 4 may be formed as a microprocessor performing, on an alternating basis, the functions of the control unit 15 and the cost calculator 4. The broadcast unit 8 may be formed as a device capable of transmitting/receiving a digital signal carrying audio and video data, files or messages. The consumer unit 10 is formed as a device capable of receiving/transmitting and interpreting the received digital signal, i.e., processing it and representing the result in the form of images and sounds. The authorization unit 16 is formed as a device sending signals permitting or prohibiting any kinds of instructions and operations to the control unit 15. The cost calculator 4 is formed as a processor, accumulator and multiplier.

The broadcast unit 8 and the consumer unit 10 are interconnected by means of a communication line.

The first 1, second 2, third 3, fourth 5, fifth 6, sixth 7, seventh 9, eighth 11, ninth 13, tenth 12 and eleventh 14 storage units as well as the control unit 15, the consumer unit 10, the broadcast unit 8, the authorization unit 16 and the cost calculator 4 are connected to the data transmission bus.

The authorization unit 16 is connected to the control unit 15.

### Utilization of the Invention

The device of this invention operates as follows: When a seller accesses the system for the first time, his call is recorded in the sixth storage unit 7, his name is recorded (meaning that a specific cell is assigned in the storage unit holding the referenced values) in the list of sellers in the third storage unit 3, the list of services offered by the seller is recorded in the fifth storage unit 6, the list of prices of the seller's services is recorded in the seventh storage unit 9, and the seller's account data are recorded in the fourth storage unit 5.

When a buyer accesses the system for the first time, his call is recorded in the ninth storage unit 13, his name is recorded in the list of buyers in the first storage unit 1, the list of ordered services is recorded in the tenth storage unit 12, the purchase prices of the services are recorded in the eighth storage unit 11, and the buyer's account data are recorded in the eleventh storage unit 14.

To meet the buyer's order for services, the list of sellers is retrieved from the third storage unit 3. The information about the ordered service is verified with the corresponding seller (a digital signal is transmitted), whereupon the consumer unit 10 is connected to the control unit 15 which asks the authorization unit 16 for permission for said seller to provide the ordered service to said buyer.

Once permission to provide the service is given, the control unit 15 signals the broadcast unit 8 to establish a connection with the consumer unit 10, and the communication line between the consumer unit 10 and the broadcast unit 8 is activated.

In addition to transmitting the signal to the consumer unit 10, the broadcast unit 8 also transmits information about the amount of time and volume of information transferred to the control unit 15 which transmits the data to the cost calculator 4.

The control unit 15 transmits information about the status of the buyer's account from the eleventh storage unit 14 to the cost calculator 4 which also receives information about the amount and cost of the services consumed, and the resultant value is recorded by the control unit 15 in the eleventh storage unit 14.

Upon each operation involving a change in the buyer's account data stored in the eleventh storage unit 14, the control unit 15 transmits to the cost calculator 4 information about the status of the provider's account from the second storage unit 2 and information about the status of the seller's account from the fourth storage unit 5. Using its built-in coefficients, the cost calculator 4 calculates the cost of the information received on the basis of its unit cost and quantity. The control unit 15 forwards said data from the broadcast unit 8 and from the seventh storage unit 9 holding the prices of the services. The control unit 15 receives the resultant values from the cost calculator 4 and records them, respectively, in the second 2, fourth 5, and eleventh 14 storage units. Thus, upon completion of said operations, the eleventh storage unit 14 contains a record of the new status of the buyer's account, the second storage unit 2 contains a record of the new status of the provider's account, and the fourth storage unit 5 contains a record of the new status of the seller's account.

Any time the seller or buyer accesses the system, the authorization unit 16 checks whether permission is granted and, if no permission is given, all further operations by the buyer or seller are blocked.

If the parameters and conditions recorded in the authorization unit 16 are not met, access is blocked.

As data are transmitted from the broadcast unit 8 to the consumer unit 10, the consumer unit 10 can also start transmitting data to the broadcast unit 8.

If a connection has been established between the consumer unit 10 and the broadcast unit 8, the communication may be interactive, meaning that depending on the contents of the data received the receiving unit is able to start transmitting data whose contents will be dependent on said received data.

The present invention makes it possible to vary the number of broadcast and consumer units as well as the storage units connected thereto (fourth, fifth, sixth, seventh, eighth, ninth, tenth and eleventh storage units).

This invention provides for an ability to make settlements among the seller, the buyer and the provider inside the device.

One broadcast unit can establish several lines of communication with the consumer units.

The broadcast unit can modify the data to be transmitted depending on the data received from the consumer unit.

1. (canceled)

2. A broadcast device for ordering services which allows for addition of a variable number of broadcast units and consumer units comprising the components:
at least one broadcast unit,
at least one consumer unit,
a control unit,
a sellers information storage unit,
a buyers information storage unit,
an authorization unit,
a communication line, and
a cost calculator;
wherein said broadcast device comprises the following features:
said broadcast device is configured to retrieve, upon request from a buyer, seller information from said sellers information storage unit,
said broadcast device is configured so that said seller information can be verified with the seller,
said control unit is configured to connect said consumer unit to said authorization unit,
said authorization unit is configured to grant or deny authorization for said seller to provide service to buyer upon request from said buyer,
if said authorization is granted, said control unit is configured to activate said communication line enabling communication between said consumer unit and said broadcast unit and allowing said seller to provide said service to said buyer,
said broadcast unit is configured to transmit to said cost calculator the amount of time and volume of data associated with said communication between said consumer unit and said broadcast unit;
wherein said services are ordered using said broadcast device without limitation on the number of broadcast units or consumer units.

3. The broadcast device unit of claim 2 further comprising:
more than one broadcast unit.

4. The broadcast device unit of claim 2 further comprising:
more than one consumer unit.

5. The broadcast device unit of claim 2 further comprising:
more than one broadcast unit and more than one consumer unit.

6. The broadcast device unit of claim 2 further comprising:
when the seller accesses the broadcast device for the first time, the broadcast device is configured to record seller's information.

7. The broadcast device unit of claim 6 wherein said recorded seller's information further comprises one or more of the following items:
seller's call, seller's name, a list of services offered by the seller, a list of prices for said seller's services and seller's account data.

8. The broadcast device unit of claim 2 further comprising:
when the buyer accesses the broadcast device for the first time, the broadcast device is configured to record buyer's information.

9. The broadcast device unit of claim 8 wherein said recorded buyer's information further comprises one or more of the following items:
buyer's call, buyer's name, a list of services ordered by the buyer, purchase price of services ordered by the buyer and buyer's account data.
